(19) United States
(12) Patent Application Publication
(10) Pub. No.: US 2010/0127855 A1
(43) Pub. Date: May 27, 2010

(54) AUTHENTICATION WITHIN A PACKAGE

(76) Inventors: MEIR ZUCKER, Yahud (IL); Amit Rosner, Yahud (IL)

Correspondence Address: DANIEL J SWIRSKY, 55 REUVEN ST., BEIT SHEMESH, 99544, IL

(21) Appl. No.: 12/276,504

(22) Filed: Nov. 24, 2008

(51) Int. Cl. G08B 21/00

(52) U.S. Cl. 340/540

(57) ABSTRACT

A closed package comprising an outer protection material for protecting an electronic device placed inside the package. The closed package includes an extension cord for coupling the electronic device with an external power source, such that it is possible to turn on the electronic device without opening the disposable package. Alternatively, closed package includes a hole enabling the connection of an external power source to the electronic device.

### BACKGROUND OF THE INVENTION

Many electronic devices available on the market are fake. Others do not operate properly. When buying an electronic device, there may be a need to check the device's operability and/or authenticity. In some cases, the electronic device is placed inside a closed package and there is a need to check the operability and/or authenticity without opening the package.

Basic principles and details relating to communication and product authentication needed for properly understanding the embodiments of the present invention are provided herein. Complete theoretical descriptions, details, explanations, examples, and applications of these, related subjects, and phenomena are readily available in standard references in the fields of communication, encryption, and authentication.

### SUMMARY OF THE INVENTION

In one embodiment, a closed disposable package comprising: an outer protection material for protecting an electronic device placed inside the disposable package; and an extension cord for coupling the electronic device with an external power source, such that it is possible to turn on the electronic device without opening the disposable package.

In one embodiment, a device comprising: an electronic apparatus comprising a short range communication element; a removable outer package encapsulating at least part of the electronic apparatus, wherein the removable outer package is removed before operating the electronic apparatus regularly; and an electrical connector for connecting the electronic apparatus to an external power source while the electronic apparatus is still inside the removable outer package.

In one embodiment, a closed disposable package comprising: an outer protection material for protecting a consumer electronics device placed inside the disposable package; a hole in the disposable package, the hole enabling the connection of an external power source to the consumer electronics device, such that it is possible to turn on the consumer electronics device without opening the disposable package.

In one embodiment, a kit comprising: a consumer electronics device to be placed inside a closed exterior package, the consumer electronics device comprising a short range communication element; and an electrical connector for connecting the consumer electronics device to an external power source while the consumer electronics device is inside the closed exterior package; wherein, while the consumer electronics device is inside the closed exterior package, at least the short range communication element of the consumer electronics device turns on upon connecting the consumer electronics device to the external power source; wherein the powered consumer electronics device can communicate with an external wireless device utilizing its short range communication.

In one embodiment, a method for communicating with an electronic device placed inside a closed disposable package, the closed disposable package comprising an electrical connector for coupling the electronic device with an external power source, the method comprising: connecting the external power source to the electrical connector; turning on at least a short range communication element of the electronic device; and using the short range communication element to communicate with an external wireless device, while the electronic device is still inside the closed disposable package.

In one embodiment, a method for testing an electronic device placed inside a closed disposable package, the closed disposable package comprising an electrical connector for coupling the electronic device with an external power source, the method comprising: connecting the external power source to the electrical connector; running a predefined task on the electronic device; and displaying the result on the electronic device while the electronic device is still inside the closed.

Implementations of the disclosed embodiments involve performing or completing selected tasks or steps manually, semi-automatically, fully automatically, and/or a combination thereof. Moreover, depending upon actual instrumentation and/or equipment used for implementing the disclosed embodiments, several embodiments could be achieved by hardware, by software, by firmware, or a combination thereof. In particular, with hardware, embodiments of the invention could exist by variations in the physical structure. Additionally, or alternatively, with software, selected functions of the invention could be performed by a data processor, such as a computing platform, executing software instructions or protocols using any suitable computer operating system.

### BRIEF DESCRIPTION OF THE DRAWINGS

The embodiments are herein described, by way of example only, with reference to the accompanying drawings. No attempt is made to show structural details of the embodiments in more detail than is necessary for a fundamental understanding of the embodiments. In the drawings:

FIG. 1A is a schematic diagram illustrating one embodiment of the invention for authenticating an electronic device placed inside a closed package;

FIG. 1B is a schematic diagram illustrating one embodiment of the invention for authenticating an electronic device placed inside a closed package;

FIG. 2 is a schematic diagram illustrating one embodiment of the invention for authenticating an electronic device placed inside a closed package;

FIG. 3 is a schematic diagram illustrating one embodiment of the invention for authenticating an electronic device placed inside a closed package;

FIG. 4 is a flow diagram of one embodiment of the invention;

FIG. 5 is a flow diagram of one embodiment of the invention; and

FIG. 6 is a flow diagram of one embodiment of the invention.

### DETAILED DESCRIPTION OF THE INVENTION

In the following description, numerous specific details are set forth. However, the embodiments of the invention may be practiced without some of these specific details. In other instances, well-known hardware, software, materials, structures and techniques have not been shown in detail in order not to obscure the understanding of this description. In this description, references to “one embodiment” or “an embodiment” mean that the feature being referred to may be included in at least one embodiment of the invention. Moreover, separate references to “one embodiment” in this description do not necessarily refer to the same embodiment. Illustrated embodiments are not mutually exclusive, unless so stated and except as will be readily apparent to those of ordinary skill in the art. Thus, the invention may include any variety of combinations and/or integrations of the embodiments described herein. Also herein, flow diagrams illustrate non-limiting embodiment examples of the methods, and block diagrams illustrate non-limiting embodiment examples of the devices. Some operations in the flow diagrams may be described with reference to the embodiments illustrated by the block diagrams. However, the methods of the flow diagrams could be performed by embodiments of the invention other than those discussed with reference to the block diagrams, and embodiments discussed with reference to the block diagrams could perform operations different from those discussed with reference to the flow diagrams. Moreover, although the flow diagrams may depict serial operations, certain embodiments could perform certain operations in parallel and/or in different orders from those depicted. Moreover, the use of repeated reference numerals and/or letters in the text and/or drawings is for the purpose of simplicity and clarity and does not in itself dictate a relationship between the various embodiments and/or configurations discussed. Furthermore, methods and mechanisms of the embodiments will sometimes be described in singular form for clarity. However, it should be noted that some embodiments may include multiple iterations of a method or multiple instantiations of a mechanism unless noted otherwise. For example, when a controller or an interface are disclosed in an embodiment, the scope of the embodiment is intended to also cover the use of multiple controllers or interfaces.

The disclosed embodiments may be implemented with almost any electronic device comprising a short range communication element. Examples of short range communication elements include, but are not limited to, Bluetooth, Wi-Fi, ZigBee, Near Field Communication (NFC), Radio Frequency Identification (RFID), Wireless USB, Ultra WideBand (UWB), or Wibree. In some embodiment, the electronic device may be a consumer electronics apparatus for home use.

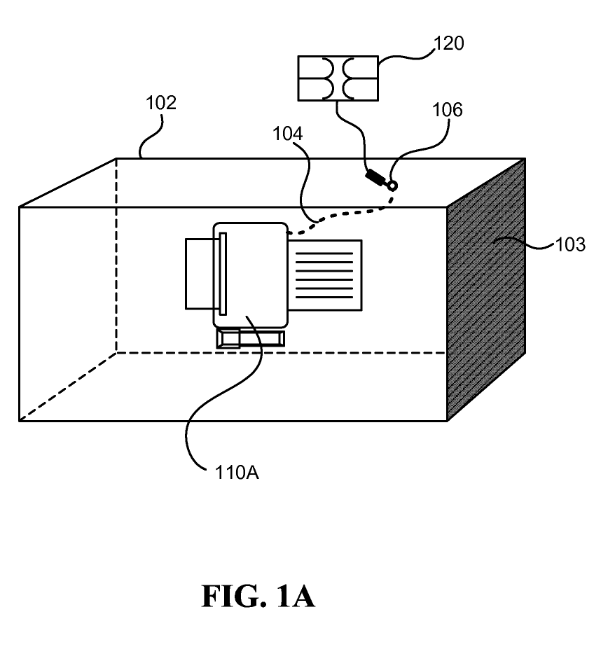

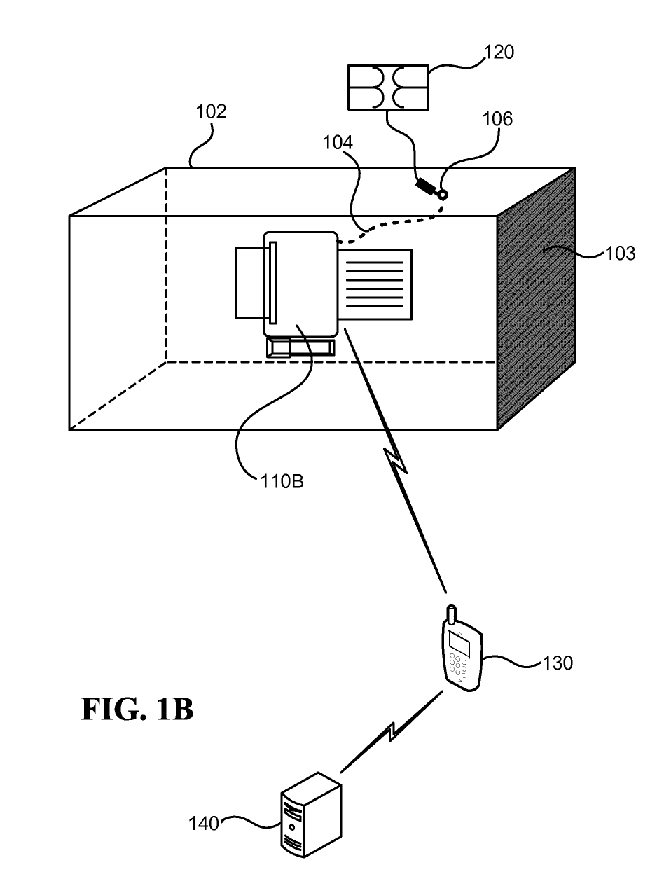

FIG. 1A illustrates a closed disposable package 102 for storing an electronic device 110A. The closed disposable package includes an outer protection material for protecting the stored content and an extension cord 104 for coupling the electronic device 110A with an external power source 120, such that it is possible to turn on the electronic device 110A without opening the disposable package 102.

The extension cord 104 may be made of almost any suitable conductive material, such as copper. In one embodiment, the extension cord 104 is a disposable extension cord. Optionally, the extension cord 104 is integrated with the disposable package 102. Optionally, the extension cord 104 ends with an electrical connector 106 which may be connected to the external power source 120.

The disposable package 102 may be sealed, approximately sealed, water proof, and/or may feature any other characteristics required for a specific need. In one embodiment, the disposable package includes at least one transparent section through which the user may receive a visual indication, such as a visual indication that the electronic device 110A is on. For example, one side 103 may be transparent and the electronic device 110A may disperse light or operate a display for presenting predefined messages to the user.

FIG. 1B illustrates a closed disposable package 102 for storing an electronic device 110B. The electronic device 110B comprises a short range communication element enabling it to transmit, to a second short range communication device 130, certain data while it is still inside the closed disposable package. For example, the short range communication element may be utilized for transmitting the results of a built in test (BIT) or a functionality test. This utility enables a user to check whether the powered electronic device (meaning a device coupled to the external power source 120) works properly while it is still inside the closed disposable package 102. Additionally or alternatively, the short range communication element may also be utilized for authentication purposes, such as symmetric or asymmetric authentication processes. For example, the electronic device 110B may communicate with the optional second short range communication device 130, which may, or may not, communicate with the optional server 140, for implementing a challenge-response authentication process, or any other required process. In one embodiment, the second short range communication device 130 includes a display, and some of the data received by the second short range communication device 130 from the electronic device 110B is displayed on the display. For example, the second short range communication device 130 may be a cellular phone, personal computer, or a PDA comprising Bluetooth and a display, and the results may be displayed on the display.

In one embodiment, the electronic device (110A or 110B) turns on automatically when it is connected to the external power source 120. Optionally, the electronic device (110A or 110B) includes means, such as a switch or a safety-catch, enabling it to determine whether or not it is inside the disposable package 102. The ability to determine whether or not the electronic device (110A or 110B) is inside the disposable package 102, enables the electronic device (110A or 110B) to operate differently when inside the disposable package 102 and outside the disposable package 102. For example, while the electronic device 110B is inside the disposable package, it may operate its short range communication element for communicating with the external wireless device 130 upon its connection to the external power source 120. While the electronic device 110B is outside of the disposable package, it may enter a standby mode of operation, which does not operate the short range communication element. In one embodiment, the electronic device further comprises an internal power source, such as a battery. In this case, a disconnected internal power source may indicate that the electronic device is inside the disposable package. Therefore, the electronic device may turn on automatically when it is connected to the external power source only if the internal power source is disconnected. In one embodiment, the electronic device comprises a battery, and the electronic device turns on automatically when it is connected to the external power source only if the battery is disconnected or discharged.

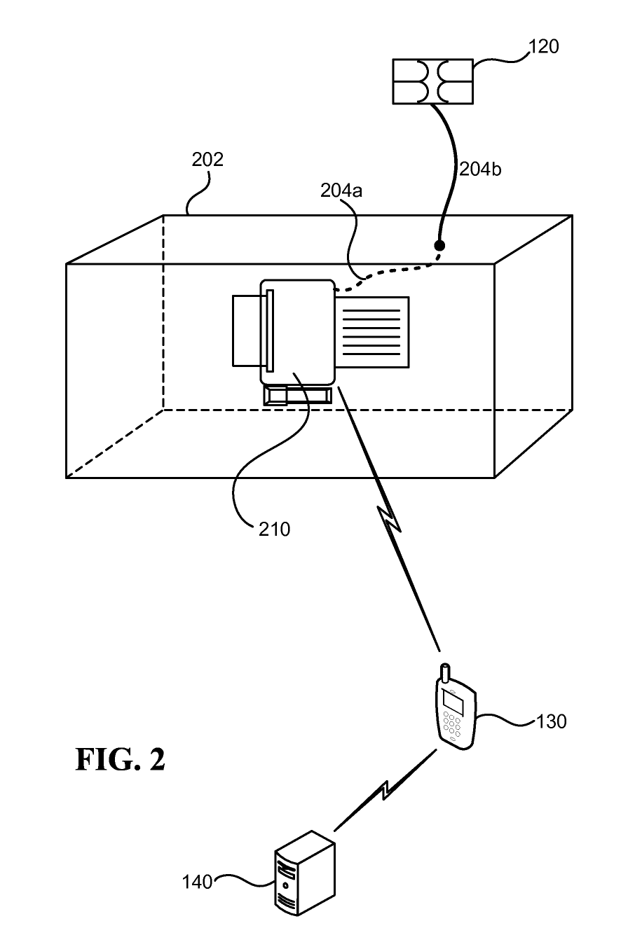

FIG. 2 illustrates one embodiment wherein an electronic apparatus 210, comprising a short range communication element, is stored inside a removable outer package 202 encapsulating just a section 204a of the electrical cord of the electronic apparatus 210. The removable outer package 202, which may be disposable, is removed before operating the electronic apparatus regularly, and this embodiment makes it possible to perform predefined operations with the electronic apparatus 210 while it is still inside the removable outer package 202. The illustrated embodiment enables a user to connect the outer section 204b of the electrical cord to the external power source 120 and then utilize a second short range communication device 130 to communicate with the electronic apparatus 210. It is to be understood that the removable outer package 202 may encapsulate almost any other portion of the electronic apparatus 210, as long as it is possible to connect the electronic apparatus 210 to the external power source 120 without having to open and/or damage the removable outer package 202.

In one embodiment, the powered electronic apparatus 210 authenticates itself, utilizing its short range communication element, while it is still inside the removable outer package 202. For example, the electronic device 210 may communicate with the optional second short range communication device 130, which may, or may not, communicate with the optional server 140, for implementing a challenge-response authentication process, or any other required process. In one embodiment, the powered electronic apparatus 210 runs a built in test, whereby the built in test enables a user to check whether the powered electronic apparatus works properly while it is still inside the removable outer package 202. The built in test results may be transmitted to a second short range communication device 130 communicating with the short range communication element of the electronic apparatus 210, in order to enable a user to estimate whether the powered electronic apparatus 210 operates properly while it is inside the removable outer package 202. In one embodiment, the second short range communication device 130 includes a display, and some of the data received by the second short range communication device 130 from the electronic device 210 is displayed on the display.

The removable outer package 202 may further include a casing which contains the electrical connector 204b and also covers at least part of the removable outer package 202. Optionally, an outer box may contain the electronic apparatus 210, the removable outer package 202, and the electrical connector 204b.

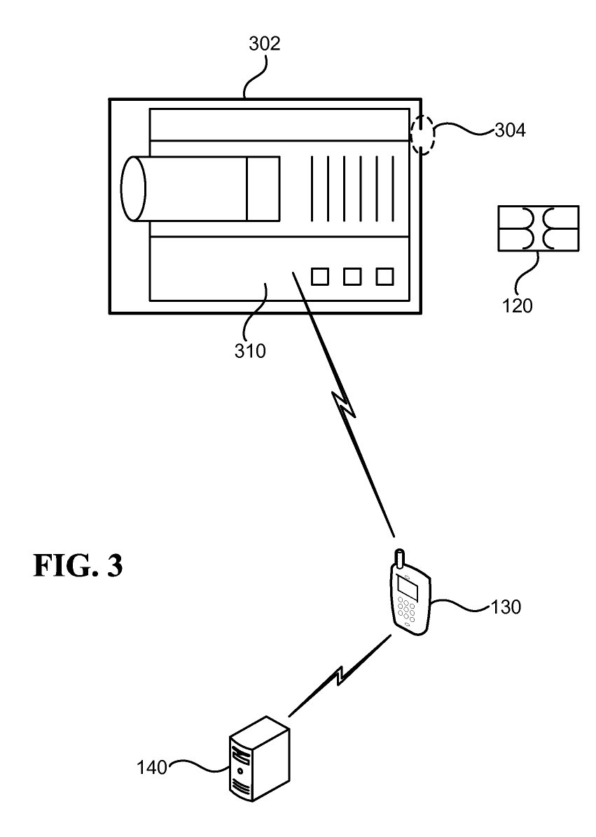

FIG. 3 illustrates one embodiment of a closed disposable package 302 featuring a hole 304. The closed disposable package 302 comprises an outer protection material for protecting a consumer electronics device 310 placed inside the disposable package 302. The hole 304 in the disposable package 302 enables connecting the consumer electronics device 310 to an external power source 120, such that it is possible to turn on the consumer electronics device 310 without opening the disposable package 302. In one embodiment, the disposable package 302 is a transparent disposable package, and a user can receive a visual indication, through the transparent disposable package, that the consumer electronics device 310 is on. Moreover, the consumer electronics device 310 may further include a display, and the visual indication may be presented on the display. In one embodiment, the consumer electronics device 310 comprises a short range communication capability and the consumer electronics device 310 can authenticate itself utilizing its short range communication capability, by communicating with a second short range communication device 130, while it is still inside the closed disposable package. For example, the electronic device 310 may communicate with the optional second short range communication device 130, which may, or may not, communicate with the optional server 140, for implementing a challenge-response authentication process, or any other required process. In one embodiment, the electronic device 310 comprises a short range communication capability and can run a built in test, whereby the built in test enables a user to check whether the powered electronic device 310 works properly while it is still inside the closed disposable package 302. In one embodiment, the second short range communication device 130 includes a display, and some of the data received by the second short range communication device 130 from the electronic device 310 is displayed on the display.

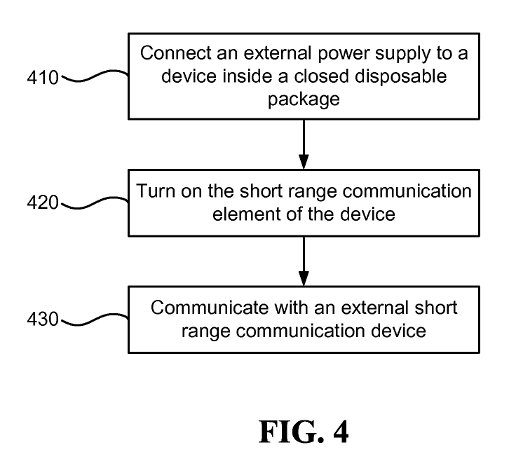

FIG. 4 illustrates a method for communicating with an electronic device placed inside a closed disposable package comprising an electrical connector for coupling the electronic device to an external power source. The method comprises the following steps: in step 410, connecting the external power supply to the electrical connector. In step 420, turning on at least the short range communication element of the electronic device, such as the Bluetooth element. And in step 430, using the short range communication element to communicate with an external wireless device (having a short range communication functionality), while the electronic device is still inside the closed disposable package. The method may further include the optional step of running a predefined task, by the electronic device, and transmitting at least some of the results of the predefined task to the external wireless device. Examples of predefined tasks include a built in test and a device authentication process. Additionally or alternatively, the method may further include the optional step of operating approximately all of the main functionalities of the powered electronic device, while the electronic device is inside the closed disposable package, and optionally transmitting at least some indications of the operated functionalities to the external wireless device. Additionally or alternatively, the method may further include the optional step of communicating with a second short range communication device, which may, or may not, communicate with an optional server, for implementing a challenge-response authentication process, or any other required process.

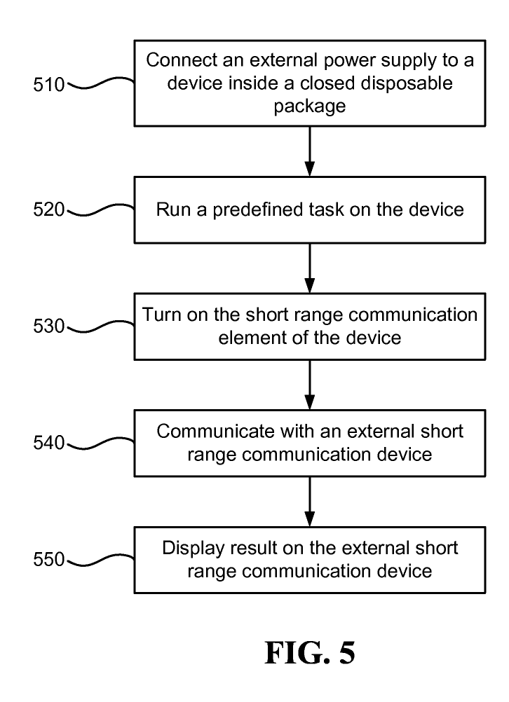

FIG. 5 illustrates a method for communicating with an electronic device placed inside a closed disposable package comprising an electrical connector for coupling the electronic device to an external power source. The method comprises the following steps: in step 510, connecting the external power supply to the electrical connector. In step 520, running a predefined task on the electronic device. Examples of predefined tasks include a built in test, operating approximately all of the main functionalities of the powered electronic device, or a device authentication process. In step 530, turning on at least the short range communication element of the electronic device, such as the Bluetooth element. In step 540, communicating with an external wireless device, such as a Bluetooth device, and transmitting at least some of the results of the predefined task to the external wireless device while the electronic device is still inside the closed disposable package. And in step 550, displaying at least some of the result of the predefined task on the external wireless device. The external wireless device may further process the received result or may display an indication correlated to the received result. For example, the external wireless device may be a cellular phone, personal computer, or a PDA comprising Bluetooth and a display, and the results may be displayed on the display.

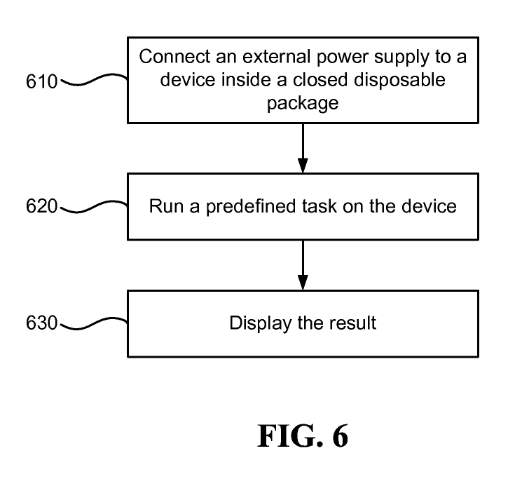

FIG. 6 illustrates a method for testing an electronic device placed inside a closed disposable package comprising an electrical connector for coupling the electronic device to an external power source. The method comprises the following steps: in step 610, connecting the external power supply to the electrical connector. In step 620, running a predefined task on the electronic device. Examples of predefined tasks include a built in test, or operating approximately all of the main functionalities of the powered electronic device. And in step 630, displaying the result on the electronic device. For example, the electronic device may include a display and at least some of the disposable package may be transparent. The electronic device may display an indication enabling a user to estimate whether the electronic device should work properly.

Certain features of the embodiments, which may have been, for clarity, described in the context of separate embodiments, may also be provided in various combinations in a single embodiment. Conversely, various features of the embodiments, which may have been, for brevity, described in the context of a single embodiment, may also be provided separately or in any suitable sub-combination.

While the methods disclosed herein have been described and shown with reference to particular steps performed in a particular order, it will be understood that these steps may be combined, sub-divided, or reordered to form an equivalent method without departing from the teachings of the embodiments. Accordingly, unless specifically indicated herein, the order and grouping of the steps is not a limitation of the embodiments.

Any citation or identification of any reference in this application shall not be construed as an admission that such reference is available as prior art to the embodiments of the present invention.

While the embodiments have been described in conjunction with specific examples thereof, it is to be understood that they have been presented by way of example, and not limitation. Moreover, it is evident that many alternatives, modifications and variations will be apparent to those skilled in the art. Accordingly, it is intended to embrace all such alternatives, modifications and variations that fall within the spirit and scope of the appended claims and their equivalents. In the claims, means-plus-function clauses are intended to cover the structures described herein as performing the recited function and not only structural equivalents, but also equivalent structures.

What is claimed is:

1. A closed disposable package comprising: an outer protection material for protecting an electronic device placed inside the disposable package; and an extension cord for coupling the electronic device with an external power source, such that it is possible to turn on the electronic device without opening the disposable package.

2. The closed disposable package of claim 1, wherein the extension cord is a disposable extension cord.

3. The closed disposable package of claim 1, wherein the disposable package is approximately sealed.

4. The closed disposable package of claim 1, wherein the electronic device comprises a short range communication capability and the electronic device can authenticate itself utilizing its short range communication capability while it is still inside the unopened disposable package.

5. The closed disposable package of claim 1, wherein the electronic device comprises a short range communication capability and the powered electronic device can run a built in test.

6. The closed disposable package of claim 1, wherein the powered electronic device can run a built in test and display the result to a user.

7. The closed disposable package of claim 6, wherein the result is displayed utilizing a display or a LED.

8. The closed disposable package of claim 1, wherein the disposable package is a transparent disposable package, and a user can receive a visual indication, through the transparent disposable package, that the electronic device is on.

9. The closed disposable package of claim 8, wherein the electronic device further comprises a display and the visual indication is presented on the display.

10. The closed disposable package of claim 1, wherein the electronic device turns on automatically when it is connected to the external power source.

11. The closed disposable package of claim 1, wherein the electronic device comprises a short range communication capability, and the electronic device can communicate with a second a second short range communication device, while it is still inside the unopened disposable package.

12. The closed disposable package of claim 11, wherein the electronic device runs a predefined tasks, transmits the result to the second short range communication device, and the second short range communication device displays a result.

13. The closed disposable package of claim 11, wherein the second short range communication device displays data received from the electronic device using the short range communication.

14. The closed disposable package of claim 11, wherein the second short range communication device communicates with a server for authenticating the electronic device.

15. A device comprising: an electronic apparatus comprising a short range communication element; a removable outer package encapsulating at least part of the electronic apparatus, wherein the removable outer package is removed before operating the electronic apparatus regularly; and an electrical connector for connecting the electronic apparatus to an external power source while the electronic apparatus is still inside the removable outer package.

16. The device of claim 15, wherein the powered electronic apparatus can operate its short range communication element while still inside the removable outer package.

17. The device of claim 16, wherein the removable outer package is disposable.

18. The device of claim 15, wherein the powered electronic apparatus authenticates itself, utilizing its short range communication element, while it is still inside the removable outer package.

19. The device of claim 15, wherein the powered electronic apparatus can communicate with a second a second short range communication device, while it is still inside the unopened disposable package.

20. The device of claim 19, wherein the second short range communication device communicates with a server for authenticating the electronic apparatus.

21. The device of claim 15, wherein the powered electronic apparatus runs a built in test, whereby the built in test enables a user to check whether the powered electronic apparatus works properly while it is still inside the removable outer package.

22. The device of claim 15, wherein the powered electronic apparatus runs a built in test and provides the result by utilizing its short range communication element, whereby the result enables a user to estimate whether the powered electronic apparatus operates properly while it is inside the removable outer package.

23. The device of claim 15, wherein the removable outer package is approximately sealed.

24. The device of claim 15, wherein the electrical connector extends out of the package.

25. The device of claim 15, wherein the electrical connector is accessed from outside the package and, at least while in use, is electrically connected to the electronic apparatus by flexible conductive wires.

26. The device of claim 15, further comprising a casing which contains the electrical connector and also encapsulates at least part of the package.

27. The device of claim 15, further comprising an outer box which contains the electronic apparatus, the package, and the electrical connector.

28. The device of claim 15, wherein the electronic apparatus is a consumer electronics apparatus for home use.

29. A closed disposable package comprising: an outer protection material for protecting a consumer electronics device placed inside the disposable package; a hole in the disposable package, the hole enabling the connection of an external power source to the consumer electronics device, such that it is possible to turn on the consumer electronics device without opening the disposable package.

30. The closed disposable package of claim 29, wherein the disposable package is a transparent disposable package, and a user can receive a visual indication, through the transparent disposable package, that the consumer electronics device is on.

31. The closed disposable package of claim 30, wherein the consumer electronics device further comprises a display and the visual indication is presented on the display.

32. The closed disposable package of claim 29, wherein the disposable package is a transparent disposable package, the consumer electronics device runs a built in test, and the result is displayed by the consumer electronics device utilizing a display or a LED.

33. The closed disposable package of claim 29, wherein the consumer electronics device comprises a short range communication capability and the consumer electronics device can authenticate itself utilizing its short range communication capability, while it is still inside the closed disposable package.

34. The closed disposable package of claim 29, wherein the consumer electronics device comprises a short range communication capability and can run a built in test, whereby the built in test enables a user to check whether the powered consumer electronics device works properly while it is still inside the closed disposable package.

35. The closed disposable package of claim 29, wherein the consumer electronics device comprises a short range communication capability and the consumer electronics device can communicate with a second a second short range communication device, while it is still inside the closed disposable package.

36. The closed disposable package of claim 35, wherein the second short range communication device communicates with a server for authenticating the electronic device.

37. A kit comprising: a consumer electronics device to be placed inside a closed exterior package, the consumer electronics device comprising a short range communication element; and an electrical connector for connecting the consumer electronics device to an external power source while the consumer electronics device is inside the closed exterior package; wherein, while the consumer electronics device is inside the closed exterior package, at least the short range communication element of the consumer electronics device turns on upon connecting the consumer electronics device to the external power source; wherein the powered consumer electronics device can communicate with an external wireless device utilizing its short range communication.

38. The kit of claim 37, wherein the consumer electronics device further comprises an internal power source, and the consumer electronics device turns on automatically when it is connected to the external power source only if the internal power source is disconnected.

39. The kit of claim 38, wherein the internal power source is a battery.

40. The kit of claim 37, wherein the consumer electronics device further comprises a battery, and the consumer electronics device turns on automatically when it is connected to the external power source only if the battery is disconnected or discharged.

41. The kit of claim 37, wherein the closed exterior package is disposable.

42. The kit of claim 37, wherein the closed exterior package is approximately sealed.

43. The kit of claim 37, wherein the consumer electronics device can run a built in test, whereby the built in test enables a user to check whether the consumer electronics device works properly while it is inside the closed exterior package.

44. The kit of claim 37, wherein the powered consumer electronics device runs a built in test and provides the result by utilizing its short range communication element, whereby the result enables a user to estimate whether the consumer electronics device operates properly while it is still inside the closed exterior package.

45. The kit of claim 37, wherein the powered consumer electronics device authenticates itself utilizing its short range communication.

46. The kit of claim 37, wherein the powered consumer electronics device authenticates itself and provides data regarding its operability utilizing its short range communication element.

47. A method for communicating with an electronic device placed inside a closed disposable package, the closed disposable package comprising an electrical connector for coupling the electronic device with an external power source, the method comprising: connecting the external power source to the electrical connector; turning on at least a short range communication element of the electronic device; and using the short range communication element to communicate with an external wireless device, while the electronic device is still inside the closed disposable package.

48. The method of claim 47, further comprising the step of running a predefined task, by the electronic device, and transmitting the task's result to the external wireless device.

49. The method of claim 48, wherein the predefined task comprises a built in test.

50. The method of claim 48, wherein the predefined task comprises a device authentication.

51. The method of claim 48, wherein the external wireless device displays at least some of the received result.

52. The method of claim 48, wherein the external wireless device further displays an indication correlated to the received result.

53. The method of claim 47, further comprising operating approximately all of the main functionalities of the powered electronic device while the electronic device is inside the closed disposable package.

54. The method of claim 47, further comprising the step of communicating with a server through the external wireless device.

55. The method of claim 54, further comprising the step of utilizing the server for authenticating the electronic device.

56. The method of claim 54, further comprising the step of utilizing the server for authenticating the electronic device using a challenge-response process.

57. A method for testing an electronic device placed inside a closed disposable package, the closed disposable package comprising an electrical connector for coupling the electronic device with an external power source, the method comprising: connecting the external power source to the electrical connector;
running a predefined task on the electronic device; and displaying the result on the electronic device while the electronic device is still inside the closed disposable package.

58. The method of claim 57, wherein the predefined task comprises a built in test

59. The method of claim 57, wherein the predefined task comprises operating approximately all of the main functionalities of the electronic device.

60. The method of claim 57, wherein the electronic device comprises a display and at least some of the disposable package is transparent.
